(19) United States
(12) Patent Application Publication
(10) Pub. No.: US 2008/0272263 A1
(43) Pub. Date: Nov. 6, 2008

(54) Grill Lid Prop

(75) Inventor: Michael H. Macken, Holiday, FL (US)

Correspondence Address: Michael L. Leetzow, Esq.;Michael L. Leetzow, P.A., 5213 SHORELINE CIRCLE, SANFORD, FL, 32771, US

(73) Assignee: MACKEN PRODUCTS INCORPORATED, Holiday, FL (US)

(21) Appl. No.: 11/742,657

(22) Filed: May 1, 2007

(51) Int. Cl. E05C 17/00

(52) U.S. Cl. 248/351

(57) ABSTRACT

A grill lid prop has first and second propping elements that are compressively held to one another by a handle. The grill lid prop also includes thermometer holders, allowing the user to determine the actual cooking temperatures at two different cooking locations. The thermometer holders may be openings in the grill lid prop or attachments on tire side of the grill lid prop. The first and second propping elements are slideably movable relative to one another.

### BACKGROUND OF THE INVENTION

1. Field of the Invention

The present invention relates generally to a grill lid prop for holding a grill lid open during cooking, and more particularly to a grill lid prop that is adjustable, holds a grill lid open to prevent flare-ups and maintains the temperature in the grill at a position where the food is cooking.

2. Technical Background

There are many different grill props for holding open the lid of a grill relative to the bottom portion of the grill. The opening of the lid allows for adequate air flow into the grill and generally prevents flare-ups. However, none of these grill props can assist the user in knowing what the temperature is where the food is cooking, allowing the food to still be undercooked or overcooked (burned),

It would be desirable therefore to provide a grill lid prop that allows the user to set the opening of the lid to a level where the temperature at the cooking position remains constant, the temperature being set by the user and also allows the user to monitor that temperature without having to open and close the lid of the grill.

### SUMMARY OF THE INVENTION

Disclosed herein is a grill lid prop for holding a grill lid of a grill open relative to a grill bottom portion the grill lid prop having a first propping element, the first propping element having a first portion and a second portion, a first end and a second end, a first engaging means at the first end for engaging one of the grill lid and the grill bottom portion, and a thermometer opening extending through the first propping element adjacent the first end and configured to receive a thermometer, the second portion being an elongated portion extending from the first portion to the second end, the elongated portion having a extended opening extending along at least 50% thereof, and a second propping element slidingly movable along the first propping element and extending between a first end and a second end, the second end of the second propping element having a portion to engage the other one of the grill lid and the grill bottom portion.

In another aspect, a grill lid prop for holding a grill lid of a grill open relative to a grill bottom portion is disclosed, the grill lid prop having a first propping element, the first propping element having a first portion and a second portion, a first end and a second end, and a first engaging means for engaging one of the grill lid and the grill bottom portion at the first end, the second portion being an elongated portion extending from the first portion to the second end, the elongated portion having a elongated opening therein, and a second propping element slidingly movable along the first propping element and extending between a first end and a second end, tire second propping element having a thermometer opening adjacent the second end thereof and aligned with at least a portion of the elongated opening in the first propping element to receive a thermometer therein, the second end of the second propping element having a portion to engage the other one of the grill lid and the grill bottom portion.

In yet another aspect, the present invention is directed to a grill lid prop for holding a grill lid of a grill open relative to a grill bottom portion having a first prop member having a first end to engage at least one of the grill lid and the grill bottom portion, a second prop member movably connected to the first prop member and having an end configured to engage the other of the grill lid and the grill bottom portion, and a thermometer holder associated with at least one of the first prop member and the second prop member to hold a thermometer therein, the thermometer opening positioned at a location corresponding to where food is placed for cooking in the grill.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a perspective view of one embodiment of a grill lid prop according to the present invention;

FIG. 2 is an exploded view of the grill lid prop of FIG. 1;

FIG. 3 is a perspective view of the grill lid prop of FIG. 1 in an alternative position;

FIG. 4 is a side view of the grill lid prop of FIG. 1 propping open a grill lid of a grill;

FIG. 5 is a side view of the grill lid prop of FIG. 1 in a different position;

FIG. 6 is a side view of a second embodiment of a grill lip prop according to the present invention; and

FIG. 7 is a perspective view of a third embodiment of a grill lid prop according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

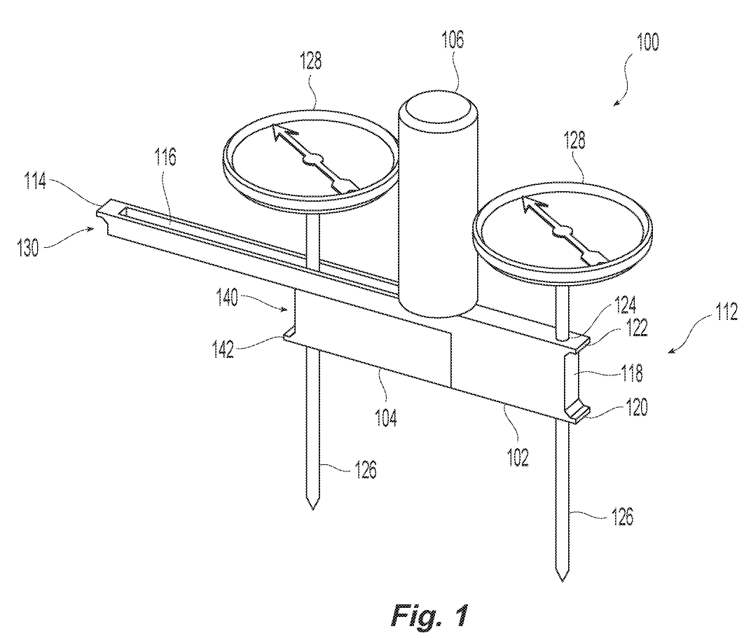

Referring to FIG. 1, a grill lid prop 100 is illustrated as having a first propping element 102 and a second propping element 104. The first propping element 102 and the second propping element 104 are compressively held relative to one another by handle 106.

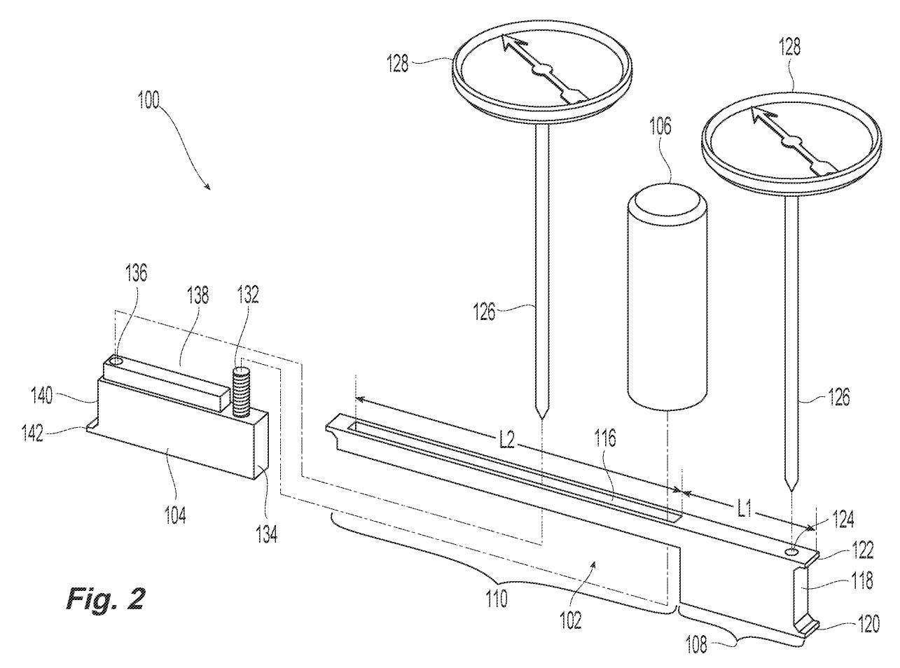

The first propping element 102 has a first portion 108 and a second portion 110, the first portion 108 being adjacent a first end 112 and the second portion 110 being adjacent the second end 114. The first portion 108 has a first length L1 that is preferably about 2.25 in. and, as illustrated in FIG. 2, is preferably deeper than it is wide, although the width may be larger than the depth. The second portion 110 of first propping element 102 has a second length L2 that is preferably about 6.5 in and has an elongated opening 116 that preferably extends at least 50% of the length L2 and more preferably extends about 90% of the length L2.

The first end 112 has a generally concave portion 118 with two extensions 120,122 to prevent the grill lip prop 100 from being accidentally dislodged from the grill, as described in more detail below. A thermometer opening 124 that extends completely through first propping element 102 is positioned adjacent the first end 112 thereof, tire thermometer opening 124 being sized to receive the stem portion 126 of a thermometer 128. The second end 114 of first propping element 102 also has an extension 130 that can engage a portion of a grill to prop the grill lid in an open position.

The second propping element 104, as best seen in FIG. 2, preferably has the same width as first propping element 102 and is preferably shorter than the second portion 110 of first propping element 102. The second propping element 104 has a threaded post 132 adjacent a first end 134 that engages a similarly threaded opening in handle 106. The threaded post 132 is sized to pass through the elongated opening 116 so that the handle 106 can engage the threaded post 132 from the opposite side of first propping element 102. Alternatively, the handle 106 may have the threaded post 132 disposed thereon and the second propping element 104 may have a threaded opening at the same position to receive the threaded post 132 on the handle 106

The second propping element 104 also preferably has an elongated extension 136 extending upwards from the second propping element 104 to engage elongated opening 116. The extension 136 keeps the second propping element 104 slidingly engaged with the first propping element 102. The extension 136 may be longer or shorter than illustrated, but preferably has a width that prevents the second propping element 104 from moving laterally during movement relative to the first propping element 102. Second propping element 104 also has a thermometer opening 138 adjacent a second end 140, the thermometer opening 138 also being sized to receive the stem portion 126 of a thermometer 128. It should he noted that the elongated extension 136 may be eliminated if a thermometer 128 is disposed in thermometer opening 136 and the handle 106 is connected through the opening 116 to second propping element 104 as both of these elements will appropriately guide the second propping element 104 along first propping element 102.

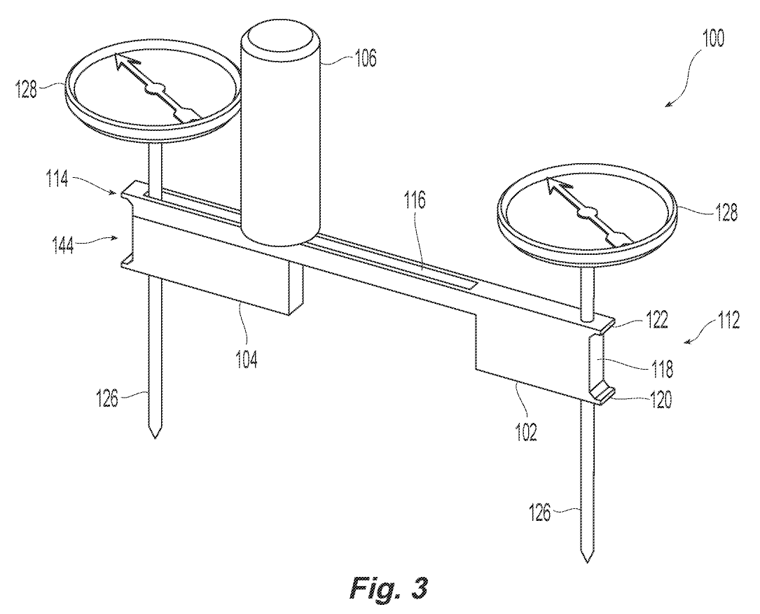

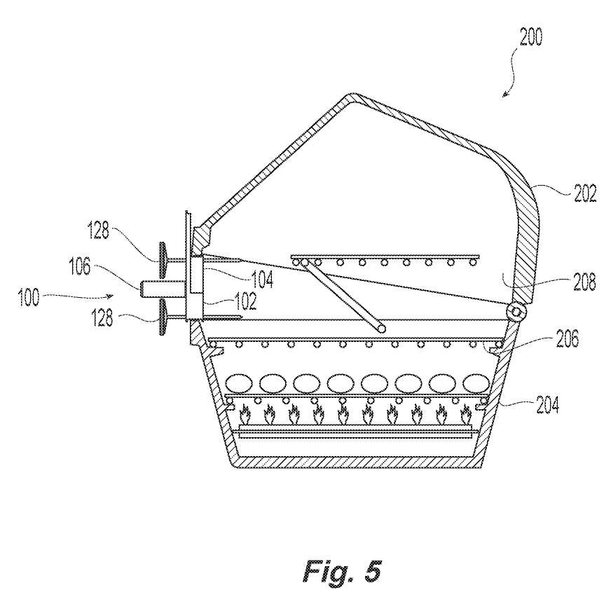

The second end 140 of second propping element 102 has an extension 142 extending therefrom, so that when the second end 140 of second propping element 104 is positioned even with the second end 114 of first propping element 102, the grill lid prop 100 has a generally concave portion 144 that is formed by two extensions 130,140, as is best illustrated in FIGS. 3 and 5.

The second propping element 104 can be slid along the first propping element 102 by simply loosening the two components (102,104) relative to one another by unscrewing the handle 106 about a turn, depending on the spacing of the threads, relieving the compressive force. The second propping element 104 can then be moved relative to the first propping element 102 to set the appropriate distance for the opening of the grill lid and then the handle 106 is tightened to hold the second propping element 104 relative to the first propping element 102. Preferably the handle 106 is made from wood, but it may be made of any appropriate material that does not become too hot during use of the grill lid prop 100. Additionally, other ways of compressively holding the first propping element 102 relative to the second propping element 104 come within the scope of the invention as well. For example, the handle may be independently attached to the grill lid prop 100 and have a separate screw or other compressive force to hold the first propping element 102 relative to the second propping element 104.

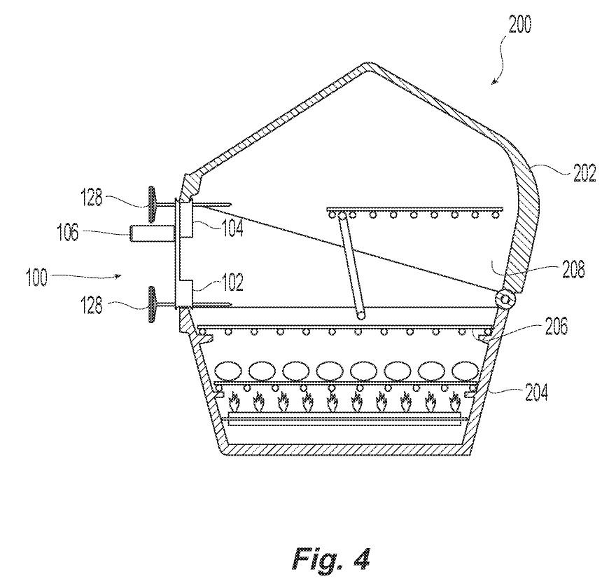

The use of the grill lid prop 100 will now be described with reference to FIG. 4. The grill lid prop 100 is used with a grill 200 having a grill lid 202 and a grill bottom portion 204. The grill 200 also has a first position 206 for grilling food, which generally corresponds to the main or lower grill cooking grate 206. Most gas-fired grills also have a second or upper grill cooking grate 208, which can be referred to as a warming rack. However, the tipper grill cooking grate 208 can be used to grill or smoke food. The grill lid prop 100 illustrated in FIG. 4 has two thermometers 128, but may have only one thermometer in either of the openings 124,136. The user can move and set the second propping element 104 relative to the first propping element 102 of grill prop 100 to provide an appropriate opening between the grill lid 202 and the grill bottom portion 204 in the grill 200. As illustrated in FIG. 4, the grill prop 100 is set to hold grill lid 202 as high as possible relative to the grill bottom portion 204. In practice, a user would light the grill 200 and allow it to warm up to a steady state temperature. For most, gas grills, this temperature, when the gas is turned up to high, would be about 550° F. The user would then open the grill lid 202 and insert the grill lid prop 100 as illustrated in FIG. 4. As illustrated in FIG. 4, the concave portion 118 of the first propping element 102 engages the grill bottom portion 204. The two extensions 120,122 are disposed on either side of the lip of the grill bottom portion 204, which assist in preventing the grill lid prop 100 from being displaced from the grill 200 and the grill bottom portion 204 in particular. Simultaneously, with the second propping element 104 moved to the second end 114 of first propping element 102, the concave portion 144 engages the grill lid 202, which the extensions 130,142 assist in forming and prevent the grill lid 202 from falling off the grill lid prop 100 or the grill lid prop 100 from falling into or off the grill 200, either by accident or if the grill lid prop 100 is bumped. It should be noted that while the grill lid prop 100 is positioned in FIG. 4 such that the second propping element 104 engages the grill lid 202, the grill lid prop 100 may also be turned 180° so that the second propping element 104 engages the grill bottom portion 204 while the first propping element 102 engages the grill lid 202 and still be within the scope of the present invention. The fully extended position illustrated in FIG. 4 generally provides a lower temperature at the first and second grilling positions than other positions, such as illustrated in FIG. 5.

As illustrated in FIG. 5, the second propping element 104 may also be moved closer to the first end 112 of the first propping element 102 (or anywhere in between) so that the grill lid 202 is not held open as high as in FIG. 4. As shown, more of the second portion 110 of first propping element is disposed on the outside portion of the grill lid 202, presenting an essentially larger extension on one side of the concave portion 144. The extension 142 will continue to prevent the grill lid prop 100 from being pulled out of the opening between the grill lid 202 and the grill bottom portion 204.

As will be known to those of ordinary skill in the art, the lower the grill lid 202 relative to the grill bottom portion 204, the higher the temperature inside the grill 100. However, each grill 200 will have its own characteristics and temperatures at the cooking positions 206,208, so it is important to be able to determine the true temperatures at each of those locations. The grill lid prop 100 and the positioning of the thermometers 128 will give the user the actual temperatures at the cooking positions 206,208 due to the positioning of the thermometers 128. As seen in FIG. 4, when the grill lid 202 is propped open to the highest point, the upper thermometer 128 (adjacent the grill lid 202) is positioned next to the second or upper grill cooking grate 208. In this position it is possible to monitor the temperatures at that location. However, even when grill lid 202 is propped open to the lowest point in FIG. 5, the upper thermometer 128 (again adjacent the grill lid 202) is still positioned next to the second or upper grill cooking grate 208. The upper grill cooking grate 208 moves as the grill lid 202 is opened and closed and the upper thermometer 128 is positioned adjacent the upper grill cooking grate 208 regardless of the position of the grill lid 202 because of the movement of the upper grill cooking grate 208. Similarly, the lower thermometer 128 is always positioned adjacent the lower grill cooking grate 206. Because the lower grill cooking grate 206 does not move and the thermometer openings 124 (or opening 136 if the grill lid prop 100 is inverted from the position in FIG.4) are positioned close to the end 112 (or 114) of grill lid prop 100, the lower thermometer 128 is always is positioned at the same level as the lower grill cooking grate 206 and the temperature at that position can be measured.

If the desired temperature at either of the cooking positions are incorrect for the food being cooked, the user can adjust the second propping element 104 relative to the first propping element 102 up or down to achieve the correct temperature at the desired position.

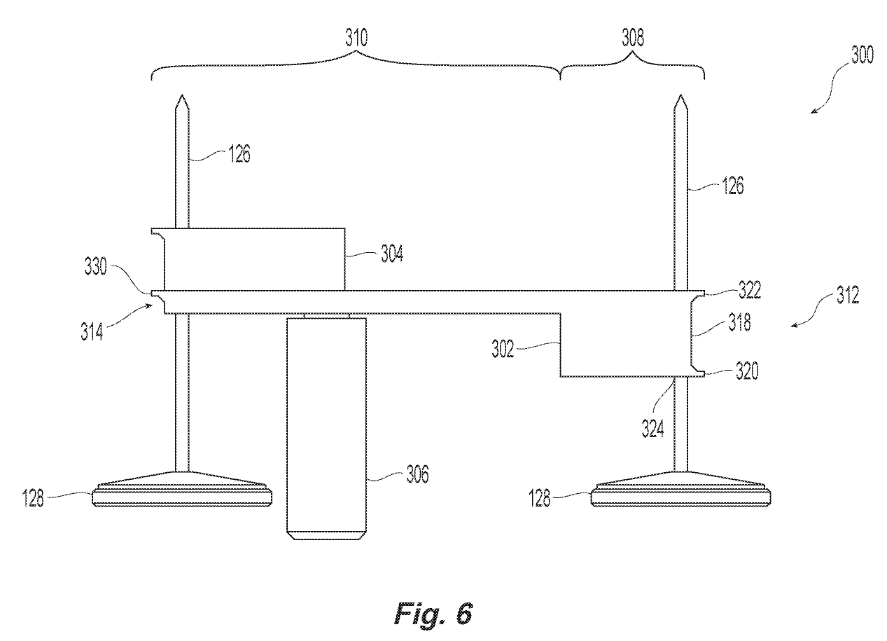

Another embodiment of a grill lid prop 300 according to the present invention is illustrated in FIG. 6. The grill lid prop 300 is similar to grill lid prop 100 and has a first propping element 302 and a second propping element 304. The first propping element 302 and the second propping element 304 are compressively held relative to one another by handle 306. The first propping element 302 has a first portion 308 and a second portion 310, the first portion 308 being adjacent a first end 312 and the second portion 310 being adjacent the second end 314. As with the previous embodiment, the first end 312 has a generally concave portion 318 with two extensions 320,322. A thermometer opening 324 that extends completely through first propping element 302 is preferably positioned adjacent the first end 312 thereof, the thermometer opening 324 being sized to receive the stem portion 126 of a thermometer 128. The second end 314 of first propping element 302 also has an extension 330 that can engage a portion of the grill 200 to prop the grill lid 202 in an open position. However, the second propping element 304 is on an opposite side of first propping element 302 from grill lid prop 100. In this configuration, the grill lid prop 300 will accommodate grills that have grill lids and grill bottom portions that may not be perfectly aligned or that may rotate in an unusual manner.

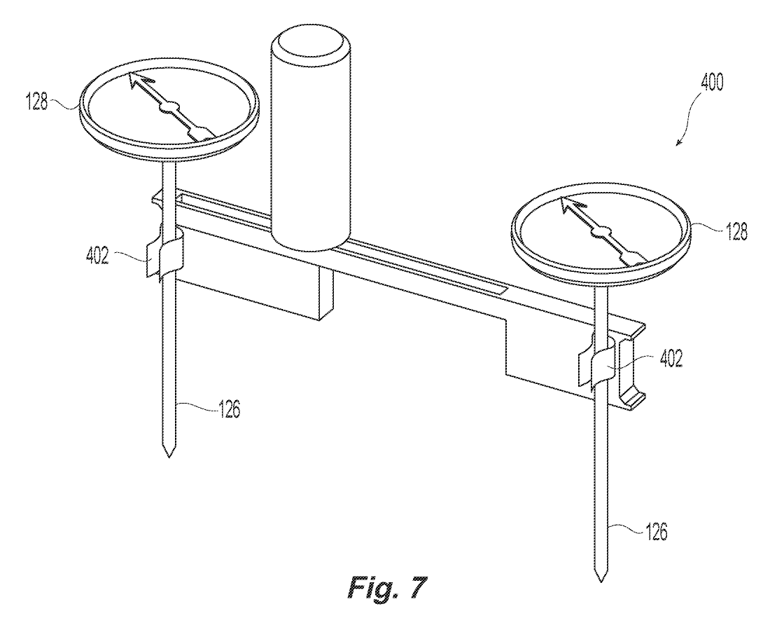

Another embodiment of a grill lid prop 400 according to the present invention is illustrated in FIG. 7. Grill lid prop 400 is the same as the grill lid prop 100, but rather than having thermometer openings, it has thermometer holders 402 that engage and hold the thermometer stems 126 of thermometers 128. The thermometer holders 402 are illustrated as being c-shaped clips positioned one side of grill lid prop 400 at about the same longitudinal position as were the thermometer openings in the prior embodiments, so that the thermometers 128 are positioned at the appropriate cooking positions 206,208 so as to monitor the temperature in the grill 200. The thermometer holders 402 are preferably flexible so that they will engage and hold the stem 126 of the thermometer 128. However, they may also be rigid and appropriately sized so that they will engage the thermometer stem 126 without having to be flexible and still come within the scope of the present invention,

It will be apparent to those skilled in the art that, various modifications and variations can be made to the present invention without departing from the spirit and scope of the invention. Thus it is intended that the present invention cover the modifications and variations of this invention provided they come within the scope of the appended claims and their equivalents.

What is claimed is:

1. A grill lid prop for holding a grill lid of a grill open relative to a grill bottom portion comprising:
a first propping element, the first propping element having a first portion and a second portion, a first end and a second end, a first engaging means at the first end for engaging one of the grill lid and the grill bottom portion, and a thermometer opening extending through the first propping element adjacent the first end and configured to receive a thermometer, the second portion being an elongated portion extending from the first portion to the second end, the elongated portion having a extended opening extending along at least 50% thereof, and
a second propping element slidingly movable along tire first propping element and extending between a first end and a second end, the second end of the second propping element having a portion to engage the other one of the grill lid and the grill bottom portion.

2. The grill lid prop according to claim 1, further comprising a thermometer disposed in the thermometer opening.

3. The grill lid prop according to claim 1, further comprising a handle, the handle being heat resistant and compressively holding the first propping element relative to the second propping element.

4. The grill lid prop according to claim 3, wherein the second propping element has a threaded member extending from a first end thereof, the threaded member configured to extend through the extended opening in the first propping element to engage a threaded portion on the handle.

5. The grill lid prop according to claim 1, the second propping element having a thermometer opening adjacent the second end thereof and aligned with at least a portion of the extended opening in the first propping element.

6. The grill lid prop according to claim 5, further comprising a thermometer disposed in at least one of the thermometer openings.

7. The grill lid prop according to claim 1, wherein the second end of the second propping element, has an upward extending portion to engage a portion of the grill.

8. The grill lid prop according to claim 1, wherein the second end of the first propping element is positioned outside the grill when the grill lid prop engages the grill lid and grill bottom portion.

9. The grill lid prop according to claim 1, wherein the thermometer opening in the first propping element is positioned at a position corresponding to a first position where food is placed for cooking in the grill.

10. The grill lid prop according to claim 5, wherein the thermometer opening in the second propping element is positioned at a position corresponding to a second position where food is placed for cooking in the grill.

11. A grill lid prop for holding a grill lid of a grill open relative to a grill bottom portion comprising:
a first propping element, the first propping element having a first portion and a second portion, a first end and a second end, and a first engaging means for engaging one of the grill lid and the grill bottom portion at the first end, the second portion being an elongated portion extending from the first portion to the second end, the elongated portion having a elongated opening therein; and
a second propping element slidingly movable along the first propping element and extending between a first end and a second end, the second propping element having a thermometer opening adjacent the second end thereof and aligned with at least a portion of the elongated opening in the first propping element to receive a thermometer therein, the second end of the second propping element having a portion to engage the other one of the grill lid and the grill bottom portion.

12. The grill lid prop according to claim 11, further comprising a thermometer opening extending through the first propping element adjacent the first end thereof, the opening configured to receive a thermometer.

13. The grill lid prop according to claim 12, further comprising a thermometer disposed in one of the thermometer openings.

14. A grill lid prop for holding a grill lid of a grill open relative to a grill bottom portion comprising:
a first propping element, the first propping element having a first portion and a second portion, a first end and a second end, a first engaging means for engaging one of the grill lid and the grill bottom portion at the first end, the second portion being an elongated portion extending from the first portion to the second end, the elongated portion having a second opening therein;
a second propping element slidingly movable along the first propping element and extending between a first end and a second end, the second end of the second propping element having a portion to engage the other one of the grill lid and the grill bottom portion; and
a thermometer opening extending through at least one of the first propping element and the second propping element adjacent to an end thereof, the thermometer opening configured to receive a thermometer therein and to locate the thermometer at a position corresponding to a position where food is placed for cooking in the grill.

15. A grill lid prop for holding a grill lid of a grill open relative to a grill bottom portion comprising:
a first prop member having a first end to engage at least one of the grill lid and the grill bottom portion;
a second prop member movably connected to the first prop member and having an end configured to engage the other of the grill lid and the grill bottom portion; and
a thermometer holder associated with at least one of the first prop member and the second prop member to hold a thermometer therein, the thermometer opening positioned at a location corresponding to where food is placed for cooking in the grill.

16. The grill lid prop according to claim 15, further comprising a handle, the handle being heat resistant and compressively holding the first propping element relative to the second propping element.

17. The grill lid prop according to claim 15, wherein the second propping element has a threaded member extending from a first end thereof, the threaded member configured to extend through the extended opening in the first propping element to engage a threaded portion on the handle.

18. The grill lid prop according to claim 15, wherein the thermometer holder is an opening extending through at least one of the first propping element and the second propping element adjacent to an end thereof, the thermometer opening configured to receive a thermometer therein and to locate the thermometer at a position corresponding to a position where food is placed for cooking in the grill.

18. The grill lid prop according to claim 15, wherein the thermometer holder is attached to at least one of the first propping element and the second propping element, the holder being flexible and having an opening on one side in communication with a central opening, the central opening having a diameter smaller than a thermometer stern.
